(19) United States
(12) Patent Application Publication
(10) Pub. No.: US 2014/0105466 A1
(43) Pub. Date: Apr. 17, 2014

(54) INTERACTIVE PHOTOGRAPHY SYSTEM AND METHOD EMPLOYING FACIAL RECOGNITION

(71) Applicants: Francois Botes, Romsey (GB); Toby Veitch, Romsey (GB); Richard Mallion, Kenley (GB); Oliver Shotter, Kenley (GB)

(72) Inventors: Francois Botes, Romsey (GB); Toby Veitch, Romsey (GB); Richard Mallion, Kenley (GB); Oliver Shotter, Kenley (GB)

(73) Assignee: Ocean Images UK Ltd., Romsey (GB)

(21) Appl. No.: 14/052,011

(22) Filed: Oct. 11, 2013

Related U.S. Application Data
(60) Provisional application No. 61/714,271, filed on Oct. 16, 2012.

(51) Int. Cl. G06K 9/00

(52) U.S. Cl. CPC G06K 9/00221
USPC 382/118

(57) ABSTRACT

A system and method for providing social photography services at locations such as Cruise Ship and Theme Parks with the purpose of giving a customer a unique identifier, associating the unique identifier with a reference imagine of the customer, and matching reference images to images shot at the locale using facial recognition techniques. A photograph gallery application is also provided, allowing customers and employees to access the facially recognized images for viewing, purchasing, and printing. This system and method employs computer based technology and facial recognition to provide fast and accurate photography production, processing, selection, printing, and sale.

### CROSS REFERENCE TO RELATED APPLICATIONS

This application claims the benefit of U.S. Provisional Application No. 61/714,271 filed on Oct. 16, 2012.

### STATEMENT REGARDING FEDERALLY SPONSORED RESEARCH OR DEVELOPMENT

N/A

### BACKGROUND OF THE INVENTION

1. Field of the Invention

The present invention generally relates to photography systems and more particularly to a social photography system and method that employs facial recognition technology.

2. Description of Related Art

Photography is a highly desirable product for many cruise ship and theme park goers. For example, in a typical cruise ship setting, various employed photographers will snap photographs of on-board guests and later upload them to a computer system. The photographs are then available for review and purchase at a photography stand somewhere on board the cruise ship. In most instances, photographs of the various on-board guests will be posted on large billboard or stands placed around or inside the on-board photography stand. At that point, the individual guests have to hunt for their photographs, decide if they like it, and then complete the purchase. This methodology has disadvantages in that it is often difficult to find your photograph in the sea of similar photographs attached to the billboards or stands. Some cruise ships and theme parks provide their guest with numbers that correspond to the photographs, but it still requires the guests to manual scan through the large number of photographs until they find their photograph. This renders the selection and purchasing process much too cumbersome and ultimately leads to a decrease in sales for the photographers. Accordingly, there is a need in the art for a simpler, more effective system and method for taking, processing, reviewing, and selling social photography.

It is, therefore, to the effective resolution of the aforementioned problems and shortcomings of the prior art that the present invention is directed. However, in view of the photography systems and methods in existence at the time of the present invention, it was not obvious to those persons of ordinary skill in the pertinent art as to how the identified needs could be fulfilled in an advantageous manner.

### SUMMARY OF THE INVENTION

The present invention provides various embodiments of a system and method concerning social photography events like Cruise Ship and Theme Park photography with the purpose of giving a the client or customer a Unique Identifier (UID), matching UID reference images to Images shot at the locale and a system and method for the user or staff at the venue to tie into the system for means of viewing and ordering photographs. This system and method employs computer based technology and facial recognition to provide fast and accurate photography production, processing, selection, printing, and sale.

Accordingly, it is an object of the present invention to provide an improved system and method for generating, matching, processing, ordering, printing and delivering photographs taken aboard a cruise ship, at an amusement park, or any desired venue or location.

It is another object of the present invention to employ facial recognition technology to compare general images to a reference image in order to more quickly identify, match, and process photographs for rapid review, ordering, and printing thereof by the user.

In accordance with these and other objects which will become apparent hereinafter, the instant invention will now be described with particular reference to the accompanying drawings.

### BRIEF DESCRIPTION OF THE DRAWINGS

FIG. 1 is flow chart depicting and describing various aspects of the system and method of the present invention relating to Client UID acquisition and the Image Capture System described herein.

FIG. 2A-2B are diagrams depicting several aspects of the Client UID acquisition system and method incorporated into the present invention.

FIG. 3 is a diagram depicting several aspects of the Image Capturing System and Data Merging features of the present invention.

FIG. 4 is an exemplary screen shot of one aspects of the Image Capture System of the present invention.

FIG. 5 is a flow chart depicting and describing various aspects of the Photo Gallery Application and related features of the present invention.

FIG. 6 is a diagram depicting various aspects of the system and method used along with the Photo Gallery App of the present invention, as well as the system used for processing and printing photographs in accordance with the present invention.

### DETAILED DESCRIPTION

The present system and method, referred to herein as the “Interactive Photo System” (IPS) comprises three primary aspects along with a number of constituent smaller parts and apps that comprise the system as a whole. The three aspects are (1) Image Capture System (2) Facial Recognition Server (FRS), and (3) Photo Gallery Application (“App”). Each aspect is described below:

### A. Image Capture System

The Image Capture System (ICS) has been created to associate guest image data with reference imaging. In one aspect, the ICS comprises a computer application defined as the Image Capture App configured to execute on a computing device, including a mobile device such as the Apple iPhone, iPod, or iPad and/or an Android device or other mobile device having an operating system. In some embodiments, the software executes within the Apple iOS environment and is compatible with iOS devices which preferably have cameras, like the iPhone 4S, iPhone 5, and/or iPad and its various iterations. The Image Capture App is executed on the computing device and presents the user with a home screen which is also the main window the App uses for acquiring scan data from barcodes.

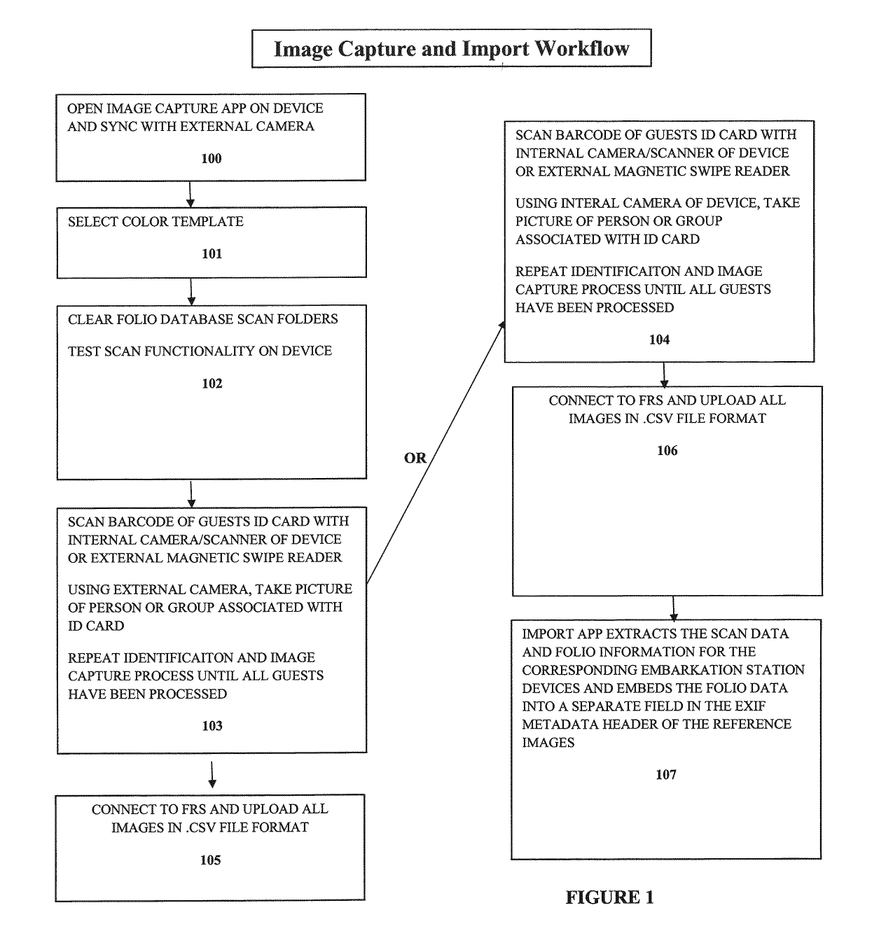

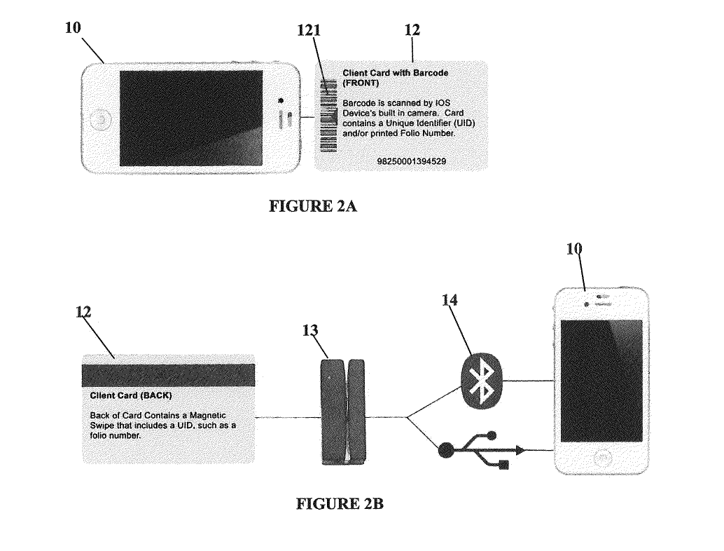

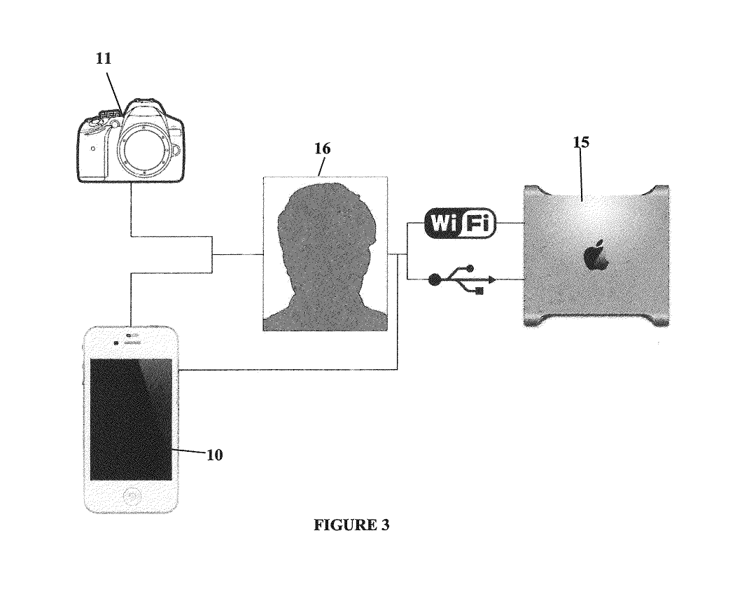

FIG. 1 is a flow chart describing one aspect of the present system and method concerning the start-up and initial reference image capturing. This initial reference image capturing may occur upon embarkation on a cruise ship or upon entry into a theme park or other similar establishment. FIGS. 2-3 show embodiments of the system components and their interaction. With references to FIGS. 1-3, in some embodiments, the system and method begins with a mobile device 10 executing the Image Capture App. At step 100, the user opens an Image Capture App and synchronizes the mobile device with a camera 11, such as a DSLR camera. The mobile device 10 and camera 11 can communicate bi-directionally but a wired or wireless connection, such as Bluetooth or WiFi. In some embodiments, the time and date is synchronized between the mobile device 10 and the camera 11. At step 101, optionally the user can select a color template for the device, which color can be used to identify the specific embarkation station or point of entry to the venue/ship where the initial photographs are captured. At step 102, the user can optionally clear the memory and/or folio database scan folders on the Image Capture App if necessary and further can test the camera and app to insure proper functionality.

At step 103, the user utilizes the Image Capture App running on the mobile device 10 to begin scanning guest identification information and capturing photographs. In some embodiments, the photographs are used as reference images for later facial recognition and image capturing. The Image Capture App presents the user with a scan function as well as a scan+photo function. The scan function uses the device's built in camera and scans the barcode off of one guest per travelling group. At embarkation or at the point of entry into a location or venue, the barcode is provided to a guest on a wrist band, on an identification card, room key, or any other accessible surface. An identification client card 12 is shown in FIG. 3 as an exemplary embodiment of an identification means including a barcode 121 and/or a magnetic strip 122 containing identification data corresponding to a guest. In some embodiments, the barcode contains information such as a folio number of a guest. The folio number may be used to identify the guest and the guest's account information, including payment information. In some embodiments, the folio number comprises a 16 digit alphanumeric identification number. Once the barcode is scanned by the user via the mobile device 10 the folio number corresponding to the guest briefly appears on the mobile device's screen together with the a blinking green indicator signaling a correct acquisition of scan data. If the scan is incomplete or incorrect, a blinking red indicator will display, prompting the user to scan again. A settings menu is also provided in the Image Capture App, wherein folders are created by data for the scan data which holds the entire card's scan data for that device for that day, in daily folders until cleared out either automatically or manually by the user.

As shown in FIG. 2B, as an alternative to using the internal camera of the user's mobile device 10 to capture the folio number, a magnetic swipe reader 13 can be connected to the mobile device 10 by way of a connection 14 which may comprise Bluetooth or wired USB. At that point, the guest can swipe a card having magnetic strip embedded with the guest's folio number. After swiping, the folio number and subsequent reference image are established as described below.

After obtaining the folio number by way of barcode scan or magnetic swipe, the camera 11 or internal camera of the mobile device 10 are used to capture an initial reference image of the corresponding guest or guests. All images shot during embarkation stage after the scan of the barcode are associated with those guests' folio number, until the next barcode or magnetic strip is scanned. This allows a single folio number to correspond to multiple guests if desired, i.e. one folio number per group of travelling passengers. In some embodiments, images of individual people, not groups of people, are used to create an initial reference image. For example, groups are associated by a booking number or other reference number and booking numbers are linked to the folio number, for instance, if a Mom, Dad and two children are travelling together in one group with one booking number (even though they might be in two cabins/staterooms), the one folio number scanned is used to associate with that booking number and all photographs following a scan is associated with that booking number until the next card with its unique folio number and its associated booking number is scanned. The association between the booking number and the folio number allows for the processing of billing and eventual payment with respect to the booking number, which typically denotes the travelers on-board or in-venue account. In alternative embodiments, a guest can establish a booking number or billing account number by providing a credit card or other payment method, which again is linked to one or more folio numbers.

As shown in step 103, the folio number is obtained through the scan or scan+photo function on the Image Capture App and subsequently a photograph of the guest is obtained by the external camera 11. Upon completion of the photo capture of the person or each person in the group, the user repeats the process until photographs of all guests have been obtained. In an alternative embodiment, shown in step 104, rather than using the camera 11, the scan+photo feature allows the operator to scan one card and use the built in camera on the mobile device 10 to take pictures of the group or individual associated with that card. Upon completion of the photo capture of the person or each person in the group, the user repeats the process until photographs of all guests have been obtained. These initial photographs are referred to herein as reference images 16 (shown in FIG. 3). The reference images 16 are used in conjunction with the folio number and related information to match subsequent photographs by way of facial recognition as further described below.

### B. Facial Recognition Server

With reference to FIGS. 1-4, once a session of scans and photographing has taken place, the scan data is uploaded to a Facial Recognition Server (FRS) 15 via WiFi or a wired connection using a computer server application such as, but not limited to, WebDav or Tethered, similar to using iTunes. In some embodiments, the software is a customized application herein referred to as the Tethered Import App. The cruise line and or ship (or event provider and venue) shares pre-determined passenger data with the present system in a computer readable data file such as a .csv file with pre-determined positions for tab data, i.e. Passenger Surname, Passenger Name, Folio Number, Stateroom Number, Booking Number and Mariners ID (the Mariner's ID is a unique ID for each guest which they receive once they have cruised a first time and is used for future bookings and UID for that guest by the line). Other passenger and guest information may also be provided depending on the type of venue, event, vessel, etc.

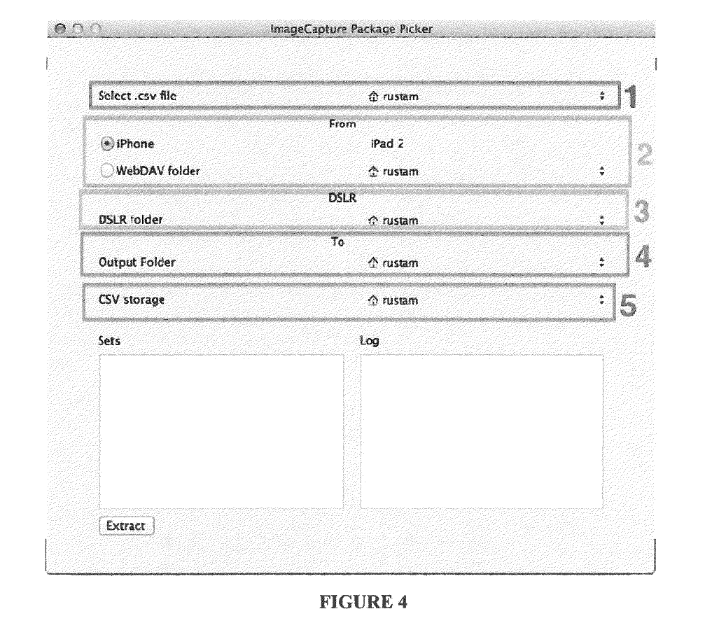

In some embodiments, as shown in steps 105 and 106 in FIG. 1 and in FIG. 4, the .csv file lies in a pre-determined folder on the FRS (Facial Recognition Server) and a CSV Editor App is used to compile one merged .csv file from a number of .csv files. A .csv file is emailed to a Photo Manager (or shared on a share point locally) each time an embarkation takes place or one or more guests embarks/disembarks a vessel or enters/leaves a venue. For example, for a cruise of 7 days it is conceivable that the Photo Manager might receive 7 updated .csv files, each containing essentially a manifest of those guests that have embarked/disembarked that particular day. The CSV Editor App takes all the .csv files inside a certain folder and merges them into one large .csv file used by the FRS 15 to reference data.

Reference images are identified and catalogued on the FRS 15 in order to create a baseline for later comparison by facial recognition. In some embodiments, a Photo Operator separates the various images captured during embarkation or entry in order to separate reference images 16 (i.e. single persons shot in a similar format as a passport picture) from the other group pictures shot during embarkation. These images are then copied from a computer workstation to the FRS 15 into a pre-determined folder according to the color code that embarkation studio or point of entry is associated with, i.e. Blue, Red, Green, etc. Accordingly, in the case where there are multiple embarkation studios or points of entry, each will be assigned a unique color such that the FRS 15 can identify where the references images were taken and/or processed.

Further shown in steps 105 and 106, the Tethered Import App is used to select which .csv file will be in use for the voyage or during the particular event. Once one or more mobile devices are connected via Tethered import or has uploaded Data to a pre-determined WebDav share folder, it recognizes the device and the data has the color code of the device embedded in the text which is being uploaded, for instance blue1234567890987654. Then, in step 107, the Tethered Import App then extracts the scan data and folio information for the corresponding embarkation station (in this example, Blue) devices and embeds the Folio data into a separate field in the EXIF metadata header of the reference images according to time stamps inside the EXIF data inside the reference images, which matches up with the time stamps of the scan data. For instance, if one passenger out of four used their card for a scan, all images following that scan (but stopping just before the next scan) will have the Folio number data of that scan embedded into the EXIF header and repeated until all reference images 16 have been matched with scan data. This process is repeated for each embarkation station or point of entry, for instance if there were four shooting stations, then the scan data will be matched with the individual passport-type images of the Blue Station, then the process is repeated for the Red Station, then Yellow Station then Green Station.

The Tethered Import App has a source folder which is updated each time a color code is used, but the output folder remains the same to group all the images that are being used as reference images into one folder. This folder and all other folders can be changed or named as desired, for example, a “Reference Images” folder. The Reference Images folder is a “hot-folder,” so each time images with their embedded EXIF information, i.e. folio number and other information, is added to that folder, it is picked up by a Facial Recognition Application, hereinafter the “FRS Application. The FRS Application is started once after installation and licensing has been applied to the product and there is in theory no need of the FRS Application to be stopped again.

As the reference images from the Blue, Red, Yellow and Green folders are copied into the Reference Images folder, the FRS Application starts to build a Biometric Wireframe of each face depicted in the Reference Images 16 by utilizing a Biometric Algorithm. In some embodiments, this algorithm is a plugin to the FRS Application and can be modified at any point in time. In one embodiment, the Biometric Algorithm comprises the Neurotec Biometric SDKNeurotech Algorithm although other biometric algorithms are known in the art.

Once the face's Biometric Wireframeface data has been created based on one or more reference images, it is stored inside the reference library of the FRS Application, called the FRS Database. The data inside the library cannot directly be accessed by the operator, but adjustments to how this library can be accessed are available in the settings windows. Once a face has been accurately scanned and added to the library, the FRS Application moves on to the next image and repeats the process until all images are processed and added to the reference library (i.e. FRS Database). Any faces that cannot be processed by the Biometric Algorithm due to loss in data or lack of clarity of the reference image are added to an Unmatched Reference folder and cannot be used to reference to, nor are displayed inside the FRS Application (only as unmatched files inside the Unmatched Reference folder). All faces will be given a reference template and any image without updated EXIF info is moved to the General Images folder, then matched to reference templates.

In the case of unmatched images, as a folio number is embedded into the unmatched images, the guests can be contacted again and can re-enroll into the system, calling back the Image Capture App and the mobile device's built in camera to quickly scan a folio card and take a picture of each person in a travelling group, repeating all the processes above and enroll them at any other point during the voyage. This last process of enrolling guests can also be used to enroll guests that opted out of being photographed during embarkation or entry but after changed their minds to be enrolled into the system somewhere during the voyage or later during their visit at the particular venue.

With reference images analyzed, embedded with EXIF information and Biometric Wireframeface data, and stored the reference images can used to conduct comparisons with later-taken photographs in order to identify the individuals in the later-taken photographs. In some embodiments, images taken onboard or at a venue generally consist of portraiture and event photography. Portraiture usually includes high quality images of guests that aren't embedded into a Photoshop template. Activity photographs include Embarkation, Gangways, Restaurant Images, Themed Photography, etc. where the picture usually is layered into a pre-determined Photoshop template and saved/printed with that template, i.e background, border, text, font, etc. . . . Some of these templates include more than one image of the same person inside one sheet/image, for instance, an individual head shot of a guest can be batched within Photoshop, then saved on a 10″×7″ size (300 dpi) template with one larger image and 4 smaller wallet sized images of the same person on the same photo/image/print.

There are two main processes in the FRS Application: face detection and face matching. The following outlines the work flow of one embodiment of the system and method of the present invention. General images are captured and sent to the FRS 15 whereby they are index into a General Images “hot folder.” After images appear in the FRS Application General Images hot-folder they are sent on face detection process. During the face detection process, the FRS Application reviews all new images, detects all possible faces and saves data of face detection into the database (output after face detection process of the image is a biometric data called “face templates” or “face data”). The face detection process on the reference images is set to detect one best face on the image. Face detection process on the general, later-taken images is set to detect all possible faces on the image. After reference images are detected and reference base is created with each photo from the reference folder becoming a separate Person in the reference database, face matching starts (the face matching of face data is very fast and is much less then 1 sec/face data).

During face matching process, the FRS Application matches face data of all Persons in the reference base with all detected faces (face data) in the general images folder. It is appreciated that images can be uploaded to the general images folder of the FRS Application on demand as pictures are taken, or at a later time in “batch” processing. The result of the face matching process of general images (face data of general images) with reference Person (face data of each reference Person) is a value which then compared with matching score (matching score is a value which defines the “border” between green and red results (between results which FRS determine as possible match and not-match to current Person)). The faces with matching score which is higher than specified in the settings “Matching Score” are shown to Operator as green results. Green results indicate a “positive match” based on a pre-determined “Matching Score” level. Positively matched photographs are added to one or more FRS output folders for later review, modification, and purchase. In some embodiments, the output folders are indexed by folio number or booking number for ease of recollection. After confirmation of green results, face data is added (referenced) to the appropriate Person and the base of the reference faces of this person becomes larger, increasing the accuracy of the reference images in the FRS database. During face matching process, the new images are matched to all faces previously confirmed to the Person, which increases accuracy of the FRS Application. In other words, the reference images library for a given person increases over time, lending to more accurate results as more and more new images are processed through the system.

There are several additional features which can be provided in the FRS aspect of the present invention. For instance, if an image has Booking ID or Folio Number in the EXIF data, for example by manual entry, then this image is sent directly to the appropriate booking folder in the FRS output folder without detection and matching. In the Photo workflow, all images are then put through a Photoshop Action and once a session has been batched, those images are copied into the General Images folder which is another hot-Folder on the FRS 15. It's important to note that the present system and method uses the templated final images and references it to the Reference Database. The system takes one of the production images and tries to match it to one of the reference images. The FRS 15 will take the first image from the General Reference Folder and try to match the face to one of the faces in the Reference Library. It also looks at the image name it's trying to match, as the 3rd character in the image name denominates if that image is embedded in a template with more than one image of the same person on the same sheet. If the system does find the delimiter as the 3rd character of the image name it will try to match only one face for that image name/number. If the 3rd place delimiter isn't present then the FRS Application will try to match ALL the faces in the image. An example of a single person in an image and a group of people follows:

For a single person image, that image is reference to the reference library database and once a match is made, it can be manually confirmed or automatically confirmed depending on a library setting. An image gets a reference score according to how certain the algorithm thinks it is with a true positive match, vs. a false positive match. In a settings window, the score can be set whereby the algorithm is very accurate and have that face automatically matched for any score above that threshold, and anything below that image is given as a match but with manual confirmation.

Once an image is matched to a reference image, the image is saved in a global image library for the voyage or duration of the guests stay, for example called “Cruise Images” and further the image can be saved in a subfolder with the folder name being the booking number of the particular guest or group of guests. This booking number folder information is acquired by the FRS, taking the folio number of the reference image that has been accurately matched, and using the booking number associated with it in the .csv file to obtain the correct booking number folder. Once this is done, the face that has been correctly matched is used to grow the reference image library for that face, so for instance, if a face is a possible match to an image in the reference library, that face will be compared to the rest of the true positive matches for that face (if any) to confirm a match.

For an image with more than one person in the picture, the FRS Application first determines that there are, for instance 4 people/faces in the image and processes each of those faces individually using the same methodology as it would if there were a single person in the image. Once those 4 matches have been made it grows the reference library of those 4 reference images to be used for future matching.

In some embodiments, if one of the 4 faces has a lower score than what would constitute in a true positive match, the App gives a selection of images in a Match window for manual matching. In some embodiments, the matches are sorted by the highest match score presented in descending order to later confirmation. If for instance 3 out of 4 faces were correctly matched, that 4th face could likely be the 4th person with the same booking number (for instance) and that person would be shown as a possible reference image match to the 4th face that is unmatched. The operator can then manually select the proper match based on the selection of images.

In some embodiments, sometimes an image might be in horizontal orientation, and if the FRS Application doesn't find any faces, the FRS Application is configured to rotate the image 90-degrees in order to attempt to detect face, repeating the rotation three times over the 270-degrees to find faces. This is an optional feature that can be turned ON/OFF in the settings.

The system will work through all the images in the General Images hot-folder and once done, all images without true positive matches, i.e. those that fall below the accuracy score threshold, will be sorted inside a Search Window, showing all unmatched images. These unmatched images are matched by scrolling through the reference library images and then confirming a positive match in the Search window. The results are sorted in descending order according to match.

Due to guests doing back to back cruising or hop on hop off cruising, a database of up to six weeks is kept. The same may be true in the case repeat visitors to a venue such as an amusement park or the like. This timescale of kept data (including reference images, general images, caches, output images) can be changed to any period up to six weeks, accommodating guests that are back to back cruisers whilst keeping the database in control. In some embodiments, for a six week database the FRS could be able to have up to 500,000 reference images in its database. The database is generally only limited by available memory and available processing power, which can be scaled as desired to fit the needed application.

To optimize the work, in some embodiments, the new face is not compared to all Persons (whole reference base), but rather all Persons in the reference base is compared to the new face. For example: if there is one Person with already 10 confirmed faces to him, the FRS Application takes this Person's data (face data of initial reference face and face data of 10 confirmed faces) and compares it to all face data of images from the general database. This database is currently optimized and efficient, taking less than 1 second to compare one new face to the whole database of images.

Further still, in some embodiments, inside each booking number folder is a subfolder called “preview”. This folder contains images of the images from the booking number parent folder, but in a rescaled smaller size. The FRS Application has the option to change the sizes from 1024 pixels long side and 72 dpi, JPG size 6 for iPad 1 and 2, to 2048 long side, 264 ppi, JPG size 6 for iPad 3 and newer use. The resized images are used by the Photo Gallery App described below and is searched over HTTP or other internet-based protocol using WebDav to minimize the bandwidth used by potentially many devices around the ship.

### C. Photo Gallery App

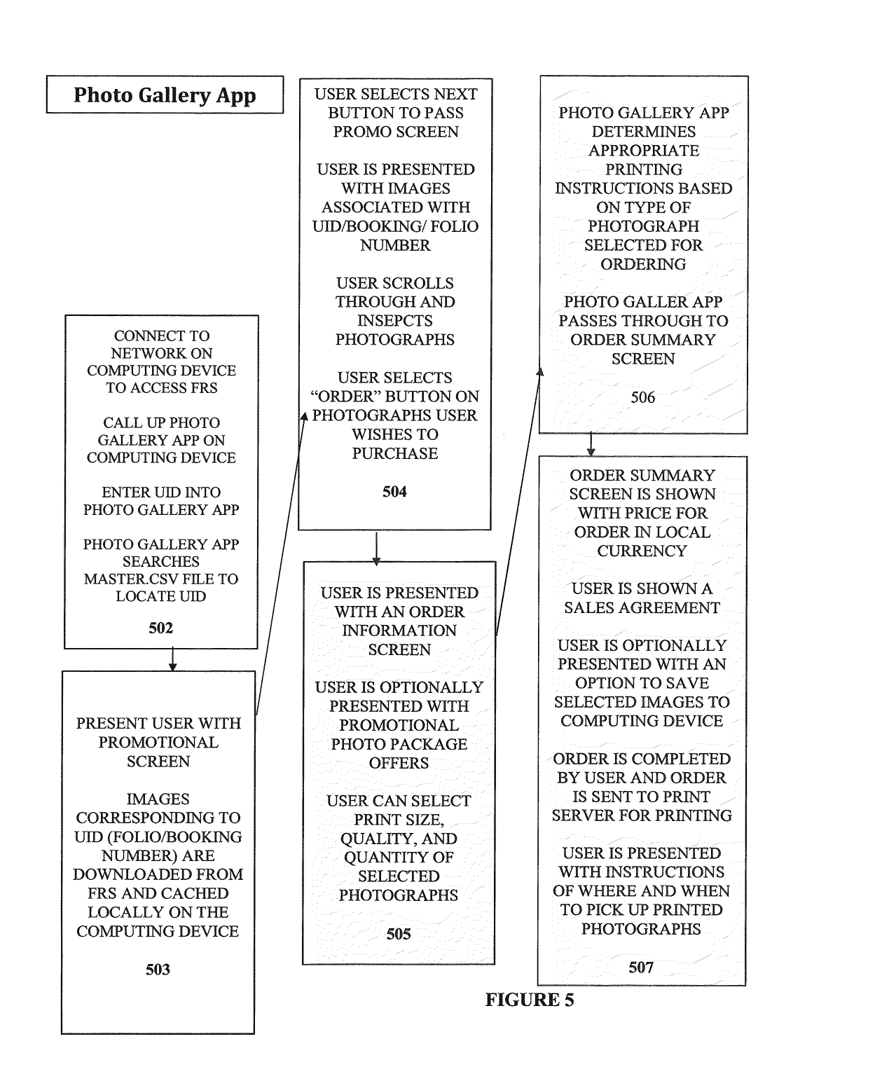

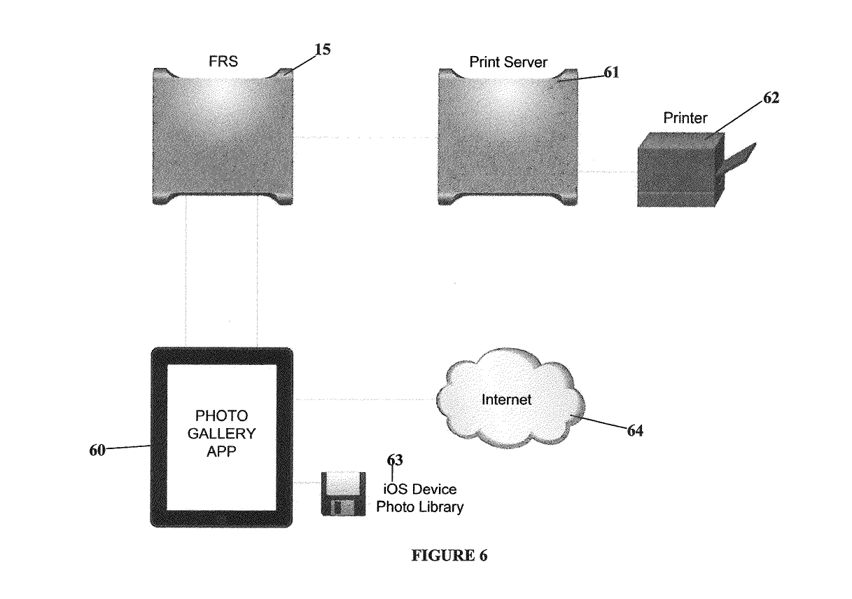

With reference to FIGS. 5-6, the Photo Gallery App is a means of viewing and ordering images inside the FRS output folders. Accordingly, it is appreciated that the FRS 15 is accessible from a variety of computing devices that are configured on the same network as the FRS 15. This allows the FRS 15 to function as a server to the computing devices for viewing and ordering of images from a plurality of locations throughout a cruise ship or venue. In some embodiments, a number of iPad's are provided at the photography stand on-board or at the venue which guests can use to view their images, or they can download a Photo Gallery App to their own mobile device for personal use. The Photo Gallery App may be connected to a local WiFi onboard the ship or at the venue which in turn has access the only to the output folder (and their booking number specifically) as well as a print server. This provides a level security for the entire system in that, in some embodiments, users can only access, review, and purchase photographs that correspond to that user's folio number and/or booking numbers. Accordingly, with reference to FIG. 6, the system components for the photo gallery amp functionality comprises a computing device 60 such as an iPad, iPhone, laptop computer, desktop computer, or similar computing device, the FRS server 15, at least one Print Server 61, at least one printer 62. The computing device 60 includes an internal photo library 63 and further the computing device 60 is connected to the Internet 64 through known wired or wireless means. The computing device 60 is in bi-directional communication with the FRS 15 and the FRS 15 is in bi-directional communication with the Print Server 61. The Print Server 61 is in communication with the Printer 62.

In step 502 shown in FIG. 5, once connected to the local WiFi on a computer device either personal or public, the user calls up the Photo Gallery App and inputs their unique identification number (UID), either as a text input in a text input screen or a scan of their barcode (available on a room key, identification card, wrist band, etc.). This UID could be the guests Folio or booking number or other unique identification number, word, or alphanumeric combination. Once UID is input, the Photo Gallery App accesses and references the .csv file and if a match is found, it proceeds to the next screen. In step 503, the user is shown a promotional (promo) screen. Whilst the promo screen is being shown, the images in the preview subfolder within a folio/booking number output folder is downloaded to the device and cached in the background. The Promo screen displays a promotional image and/or text that is changed locally onboard using the Plist Editor App. The Plist Editor App can specify an image and/or text on a local share point which is displayed as promotional information once a guest has logged into the system using one of their mobile devices, including iPhone, iPad and iPod and other like devices. The Promo screen functions essentially as a “loading screen” while images are gathered from the image server.

In step 504, once a guest finished viewing the Promo screen, they press the Browse button and are presented with the images that are in the booking number folder, associated with their folio number or UID. As is apparent, these images are those images that have previously been processed and matched in accordance with the FRS system and method described above. These images are the cached images on their device and are viewed side by side or singular, all in landscape mode to maximize real-estate space. Guests can then view and add photographs to a shopping basket. The screen will also have a copyright protection notice in the menu bar or watermark across the image, should they decide to make a screen capture of the App. This prevents the user from circumventing the purchase process. Once all the images are selected for the shopping basket per their choice, the user presses the Order button to go into the Order info screen.

In step 505, once in the Order info screen, the user is presented with a thumbnail of the selected images as well as a price, print, and quantity + and − buttons. The user can then adjust the quantities and order their selection by pressing the order selected button. In some embodiments, the order screen can present the user with promotional packages. If the user presses on a print size or print item he/she is presented with a list of products available for that image. This list, as well as the default pricing is contained in the products .plist Lookup table and is edited with the built in Plist Editor app inside the FRS. The products .plist can be changed to various items, prices, print sizes, currency, etc, as well as default items. The first to letters of an image name preamble references to item codes contained in the products .plist file, which is used by the Photo Gallery App to display defaults and print options to the user of the App. All images shot onboard are batched through Photoshop or a similar photography program and the first two or three characters of the file name are updated accordingly. The first two characters points to the product type and its print options and are contained in a .plist file which in turn is edited in the Plist Editor App. A product with code AA for instance would mean Activity and have, for example three print products with three different print pricing, or PA would mean Activity and the second character would delimit the products and its pricings. The 3rd character is to tell the FRS if it's an image or template with more than one face of the same person, for example delimited by the character @. The Photo Gallery App uses the first two characters to lookup the print products in the .plist lookup table associated with the first two characters and gives the default in the Order Summary screen, with additional items related to the print product as a drop down menu choice with item and pricing.

Once the guest has ordered an image or print package, a confirmation alert appears with a summary of the cost total and sale conditions upon which the user needs to confirm or cancel. Once confirmed and order.txt file is sent to the Print Server. In step 506, the print server can comprise existing photography printing equipment such as FujiFilm Minilab equipment, running MS01 software, with the JobMaker API plugin accepting these print jobs. In some embodiments, these FujiFilm print servers are running on Windows XP Professional with SQL Server installed. The oder.txt file (generically, but changed per user and order) has many info fields, including Name, Surname, Address (if applicable), as well as image locations, print sizes and qty, printer to be used for printing, which surface is being used and if a CD Burn is included and if so, for all the images or just the selected ones. The App has built in functionality to work out which print product is selected correctly, for instance, a print product starting with PA means portraiture and has a minimum size of 13×10 Inches with a set price. If a “Silver Package” is selected which contains 5× Portraiture package images, as example, the App will alert the user if they have selected too little or too many images and or if their images aren't all portraiture (PA), but some are Activity (AA). Once the user is happy with his/her selection, they press the “Order Selected” or “Order Package” buttons corresponding to their print product preferences. This takes them to an order summary screen shown in step 507.

In the Order Summary Screen, the user is presented with a summary of the print products they have selected, in text format, with a price in the local currency (set with the Plist Editor) for their purchase session. The user is also presented with a description of the sales agreement or purchase regulations. Once the user presses confirm, the device confirms the order. If the user purchased a digital package containing digital images, those digital images relating to their package can then be saved onto their device. The user is presented with an alert if they do or do not want to save the images into their device's Photo Library. Upon confirmation an order.txt file is sent to the Print Server which contains all relevant information about that order, including person, their room and booking number, print products selected and their paths on the network, qty, if a CD Burn is Required, etc. This is saved on a Webdav sharepoint on the FRS and an Automator script copies this file into a JobMaker API folder on the MS01 FujiFilm Print Server, which then creates a complete print job, readied for the Operator. A copy of this print job order.txt is stored on the FRS for order lookup and referencing.

Once the user has confirmed the purchase, the Photo Gallery App will display a final page, showing how to collect images, Photo Gallery times and a Thank You note, after which the Photo Gallery App logs out, clears all caches and returns to the Home/Login Screen. In some embodiments, the order.txt is initially saved on the FRS 15 in a Print Jobs folder and using an Automator Action, is copied from the WebDav Sharepoint to an SMB Sharepoint on the MS01 computer. This order.txt inside the JobMaker folder is deleted after the print job has been created and by using the Automater Action we can keep record of job orders made. A Job is then created on the MS01 computer and all the user needs to do is press process order or make color or density adjustments as needed, then press process order. The process order will print the products in its ordered sizes, paper surfaces and burn a CD with the images on, whilst a label receipt is produced. These items are then bundled inside a Photo folder and labeled and stored in the Photo Gallery for collection or delivered to the Guest Staterooms (as the label contain the guest name and stateroom number) or other location where the guest is known to be located.

Once an order is made using the Photo Gallery App, the user is presented with a choice to save a digital copy onto their device's Photo Library. If they click Yes, then the cached images, in the same dimensions and resolution of their mobile device's display is saved in their Photo Library and immediately available for uploading, printing, Tweets, Facebook, email, etc. Once a session is completed, the guests are reminded to collect their images and an OK/Confirm button will then redirect them to the Front page of the App and log them out. In some embodiments, an auto timer of 2-minutes is installed should there be no activity and ask a guest to confirm the logout or continue. With continue they can continue and if there is no input or the logout button is presses, they are redirected to the main login screen, having been logged out and the session closed and any local cached images deleted.

It is appreciated that although the present invention is generally described in the context of a cruise ship setting, the present system and method can be implemented in a variety of ways and places including in amusement parks, event venues, stadiums, arenas, parks, the like. Further, the present invention is not limited to use with the specific hardware and software mentioned above, rather the hardware and software may vary as desired provided the hardware and software is properly designed to carry out the spirit and function of the invention as fully described herein. It is further appreciated that references herein and in the attendant figures to Apple, iOS, iPhone, and iPad represent exemplary hardware and software environments; the present invention is not limited to use in such environments.

The instant invention has been shown and described herein in what is considered to be the most practical and preferred embodiments. It is recognized, however, that departures may be made therefrom within the scope of the invention and that obvious modifications will occur to a person skilled in the art.

1. An interactive photograph system, comprising:
an image capture system, a facial recognition server, and a photograph gallery application system;
said image capture system configured to obtain at least one reference photograph of at least one individual and associate a unique identifier corresponding to the identity of said individual with said reference photograph;
said facial recognition server configured to store said at least one reference image and conduct a facial recognition comparison between at least one new image and said reference image in order to identify said individual appearing in said new image;
said facial recognition server further configured to embed said unique identifier of said individual in said new image; and
said photograph gallery application system configured to recall said at least one new image from said facial recognition server and display said new image to a user for selection, ordering, and purchase.

2. The interactive photograph system of claim 1, wherein said image capture system comprises a mobile device executing an image capture application, wherein said image capture application receives said unique identifier by scanning a bar code containing said unique identifier.

3. The interactive photograph system of claim 1, wherein said at least one reference photograph is captured after said image capture system receives said unique identifier corresponding to said individual in said reference photograph.

4. The interactive photograph system of claim 1, wherein said facial recognition server is in bi-directional communication with said image capture system.

5. The interactive photograph system of claim 1, wherein said photograph gallery application system is executable on a computing device, said computing device connectable to the Internet.

6. An interactive photograph method, comprising:
upon entry or embarkation, executing an image capture application on a mobile device;
scanning, by said mobile device, a bar code containing a unique identifier corresponding to the identity of an individual;
capturing an image of said individual by way of a camera interfaced with said image capture application;
associating said unique identifier with said captured image;
uploading said captured image as a reference image to a facial recognition server, said facial recognition server in communication with said mobile device and said image capture application;
processing said reference image through a biometric algorithm to obtain reference biometric wireframe face data corresponding to the facial features of said individual in said reference image;
storing said wireframe face data on said facial recognition server;
obtaining at least one new image on said individual;
processing said new image through said biometric algorithm to obtain new biometric wireframe face data corresponding to new facial features in said new image;
comparing, on said facial recognition server, said new biometric wireframe face data with said reference biometric wireframe face data to determine whether there is a match therebetween; and
if said match is determined, associating said unique identifier with said new image.

7. The interactive photograph method of claim 6, wherein said at least one new image is recalled in a photograph gallery application executive on a computing device.

8. The interactive photograph method of claim 7, wherein said photograph gallery application system configured to recall said at least one new image from said facial recognition server and display said new image on said computing device for selection, ordering, and purchase.

9. The interactive photograph method of claim 6, wherein said facial recognition server is in communication with a print server, said print server in further communication with a printer, said printer configured to print said at least one new image.

10. The interactive photograph method of claim 6, wherein if said match is determined, said new biometric wireframe face data is added to said reference biometric wireframe face data in order to increase the accuracy of said facial recognition server.
